(19) United States
(12) Patent Application Publication
(10) Pub. No.: US 2018/0170006 A1
(43) Pub. Date: Jun. 21, 2018

(54) Rubber Composition, Rubber Composition Metal Laminate, and Vulcanized Rubber Product

(71) Applicant: The Yokohama Rubber Co., LTD., Minato-ku, Tokyo (JP)

(72) Inventor: Tomoaki Miyamoto, Hiratsuka-shi, Kanagawa (JP)

(21) Appl. No.: 15/738,551

(22) PCT Filed: Jul. 23, 2015
(86) PCT No.: PCT/JP2015/071034

§ 371 Date: Dec. 20, 2017

(51) Int. Cl. B32B 15/06; C08K 3/06; C08K 5/05; C08K 5/00; C08L 9/00; C09J 109/00

(52) U.S. Cl. CPC B32B 15/06; C08K 3/06; C09J 109/00; C08K 5/0025; C08L 9/00; C08K 5/05

(57) ABSTRACT

A rubber composition of the present technology contains: 100 parts by mass of diene polymer that can be vulcanized by sulfur, from 0.5 parts by mass to 5 parts by mass of sulfur, and from 0.8 parts by mass to 17 parts by mass of hydroxy group-containing compound having a molecular weight of 200 or less.

### TECHNICAL FIELD

The present technology relates to a rubber composition, a rubber composition metal laminate, and a vulcanized rubber product, and particularly relates to a rubber composition containing a vulcanizing agent, a rubber composition metal laminate, and a vulcanized rubber product.

### BACKGROUND ART

Conventionally, chloroprene rubber compositions for manufacturing hydraulic hose and high pressure hose in which a reinforcing layer having a surface plated with a metal such as brass is sandwiched between a pair of rubber layers have been proposed (e.g. see Japanese Unexamined Patent Application Publication No. 2001-279022). Since this rubber composition contains a vulcanization accelerator such as sulfurs and guanidines, crosslinking characteristics of a rubber layer formed from the rubber composition is enhanced, and excellent adhesion between a metal surface of a reinforcing layer and the rubber layer is achieved.

Methods of producing the hose described above include a steam vulcanization method in which the rubber composition is heated and vulcanized by steam, and an oven vulcanization method in which the rubber composition is vulcanized by an oven. Since the oven vulcanization method allows continuous vulcanization, productivity of hose can be enhanced.

However, when vulcanization of a rubber composition is performed by the oven vulcanization method, sufficient adhesion between the rubber layer and the reinforcing layer may not be always obtained due to vaporization of remarkable amount of water during the vulcanization. Therefore, there has been a demand for a rubber composition that can provide a rubber layer having excellent adhesion to a metal surface of a reinforcing layer even when vulcanization is performed by a hot-air vulcanization method such as the oven vulcanization method, besides the steam vulcanization method.

### SUMMARY

The present technology provides a rubber composition that can provide a rubber layer having excellent adhesion to metal surfaces, a rubber composition metal laminate, and a vulcanized rubber product. The rubber composition of the present technology contains: 100 parts by mass of a diene polymer that can be vulcanized by sulfur, from 0.5 parts by mass to 5 parts by mass of sulfur, and from 0.8 parts by mass to 17 parts by mass of a hydroxy group-containing compound having a molecular weight of 200 or less.

According to this rubber composition, since the content of the sulfur and the equivalent weight of hydroxy groups derived from the hydroxy group-containing compound in the rubber composition are in appropriate ranges, a catalytic function of bond forming reaction between the sulfur and a metal surface due to the hydroxy group-containing compound is efficiently exhibited. As a result, this rubber composition can provide a rubber layer having excellent adhesion to metal surfaces of reinforcing layers even when vulcanization is performed by a hot-air vulcanization method, by which the composition tends to be dried, or steam vulcanization method.

In the rubber composition of the present technology, the hydroxy group-containing compound is preferably represented by the general formula (1) below.

ROH (1)

In Formula (1), R represents a hydrogen atom, an alkyl group that may have an ether bond and a branch and that has from 1 to 5 carbons, or a hydroxy alkyl group that may have an ether bond and a branch and that has from 1 to 10 carbons and 5 or less hydroxy groups.

The rubber composition metal laminate of the present technology has a reinforcing layer having a metal surface, and a rubber layer containing the rubber composition described above provided on the metal surface.

According to this rubber composition metal laminate, since the content of the sulfur and the equivalent weight of hydroxy groups derived from the hydroxy group-containing compound in the rubber composition are in appropriate ranges, a catalytic function of bond forming reaction between the sulfur and a metal surface due to the hydroxy group-containing compound is efficiently exhibited. Such a catalytic function allows a rubber composition metal laminate having excellent adhesion between the rubber layer and the metal surface of the reinforcing layer even when vulcanization is performed by a hot-air vulcanization method, by which the composition tends to be dried, or steam vulcanization method.

In the rubber composition metal laminate of the present technology, the metal surface is preferably brass-plated. In the rubber composition metal laminate of the present technology, the reinforcing layer preferably has a braided structure in which wires are braided or a spiral structure.

A vulcanized rubber product of the present technology is obtained by using the rubber composition described above.

The vulcanized rubber product of the present technology is preferably adhered to the reinforcing layer by vulcanizing the rubber layer of the rubber composition metal laminate described above in the presence of sulfur.

The vulcanized rubber product of the present technology is preferably a hose.

According to the present technology, a rubber composition that can provide a rubber layer having excellent adhesion to metal surfaces, a rubber composition metal laminate, and a vulcanized rubber product are provided.

### BRIEF DESCRIPTION OF DRAWINGS

FIG. 1 is a schematic, partial cutaway perspective view of an example of a hydraulic hose according to an embodiment of the present technology.

FIG. 2 is an explanatory diagram of production steps of a hydraulic hose using a rubber composition according to an embodiment of the present technology.

FIG. 3 is an explanatory diagram of vulcanization steps of the hydraulic hose using the rubber composition according to the embodiment of the present technology.

FIG. 4 is a partially cross-sectional view illustrating an example of a layer structure around a mandrel inserted into a vulcanization device of production steps of a hydraulic hose using a rubber composition according to an embodiment of the present technology.

### DETAILED DESCRIPTION

Embodiments of the present technology are described in detail below with reference to the accompanying drawings. Note that the present technology is not limited to the embodiment described below and can be performed with suitable modifications.

The rubber composition according to the present embodiment contains: 100 parts by mass of a diene polymer that can be vulcanized by sulfur, from 0.5 parts by mass to 5 parts by mass of sulfur, and from 0.8 parts by mass to 17 parts by mass of a hydroxy group-containing compound having a molecular weight of 200 or less.

According to this rubber composition, since a predetermined amount of sulfur and a predetermined amount of hydroxy group-containing compound are blended to the diene rubber polymer, the content of the sulfur and the equivalent weight of hydroxy groups in the rubber composition are in appropriate ranges, and a catalytic function of bond forming reaction between the sulfur and a metal surface due to the hydroxy group-containing compound is efficiently exhibited. As a result, this rubber composition can provide a rubber layer having excellent adhesion between the rubber layer and the metal surface even when vulcanization is performed by a steam vulcanization method or a hot-air vulcanization method, by which the composition tends to be dried and by which the amount of water having the catalytic function of the bond forming reaction between the sulfur and the metal surface decreases. The components of the rubber composition according to the present embodiment are described in detail below.

### Diene Polymer

As the diene polymer, a diene polymer that can be vulcanized by sulfur is used. Here, “sulfur vulcanizable” means having a property that can form a crosslinking structure via sulfur. Examples of the other diene polymer include a natural rubber (NR), chloroprene rubber (CR), isoprene rubber (IR), styrene butadiene rubber (SBR), acrylonitrile-butadiene rubber (NBR), ethylene-propylene-diene rubber (EPDM), chlorinated polyethylene rubber (CM), and chlorosulfonated polyethylene rubber (CSM). By using these, various physical properties required for a rubber composition for hose can be exhibited at a high level. Among these, from the perspective of achieving high adhesion between the metal surface of the reinforcing layer and the rubber layer, chloroprene rubber (CR), styrene butadiene rubber (SBR), acrylonitrile-butadiene rubber (NBR), and ethylene-propylene-diene rubber (EPDM) are preferable. One type of these diene polymers may be used alone, or two or more types of these diene polymers may be used in a combination.

The compounded amount of the diene polymer is preferably from 20 mass % to 70 mass % relative to the total amount of the rubber composition from the perspective of imparting good mixing processability and good appearance to the rubber.

### Vulcanizing Agent

The rubber composition according to the present embodiment contains sulfur as the vulcanizing agent. Examples of the sulfur include powdered sulfur, precipitated sulfur, highly dispersible sulfur, surface treated sulfur, and insoluble sulfur.

The content of sulfur is from 0.5 parts by mass to 5.0 parts by mass per 100 parts by mass of the diene polymer. When the content of the sulfur is from 0.5 parts by mass to 5.0 parts by mass, bonding between the sulfur and the metal surface is sufficiently formed during the vulcanization of the rubber composition, thereby achieving sufficient adhesion between the rubber layer and the metal surface. From the perspective of adhesion between the rubber layer and the metal surface, the content of the sulfur is preferably 0.55 parts by mass or greater, more preferably 0.6 parts by mass or greater, even more preferably 0.65 parts by mass or greater, and yet even more preferably 0.7 parts by mass or greater, but preferably 3.75 parts by mass or less, more preferably 3.5 parts by mass or less, even more preferably 3.25 parts by mass or less, and yet even more preferably 3.0 parts by mass or less, per 100 parts by mass of the diene polymer. Taking these into consideration, the content of sulfur is preferably from 0.55 parts by mass to 3.75 parts by mass, more preferably from 0.6 parts by mass to 3.5 parts by mass, even more preferably from 0.65 parts by mass to 3.25 parts by mass, and yet even more preferably from 0.7 parts by mass to 3.0 parts by mass, per 100 parts by mass of the diene polymer.

The rubber composition according to the present embodiment may contain a vulcanizing agent other than sulfur in a range that the effect of the present technology can be exhibited. Examples of the vulcanizing agent other than sulfur include sulfur-based, organic peroxide-based, metal oxide-based, phenol resin, quinone dioxime, and the like. One type of these may be used alone, or two or more types of these may be used in a combination. Examples of the sulfur-based vulcanizing agent include sulfur-containing organic compounds, such as tetramethylthiuram disulfide (TMTD), tetraethylthiuram disulfide (TETD), tetrabutylthiuram disulfide (TBTD), dipentamethylenethiuram tetrasulfide (DPTT), tetrabenzylthiuram disulfide, dimorpholine disulfide, and alkylphenol disulfide.

Examples of the organic peroxide-based vulcanizing agent include dicumyl peroxide, benzoyl peroxide, t-butyl hydroperoxide, 2,4-dichlorobenzoyl peroxide, 2,5-dimethyl-2,5-di(t-butylperoxy)hexane, and 2,5-dimethylhexane-2,5-di(peroxyl benzoate).

Examples of the other vulcanizing agent include zinc oxide, magnesium oxide, resins such as phenol resin, p-quinone dioxime, p-dibenzoylquinone dioxime, poly-p-dinitrosobenzene, methylenedianiline, and the like.

### Vulcanization Accelerator

The rubber composition according to the present embodiment preferably further contains a vulcanization accelerator. Examples of the vulcanization accelerator include aldehyde-ammonia-based vulcanization accelerators, aldehyde-amine-based vulcanization accelerators, thiourea-based vulcanization accelerators, guanidine-based vulcanization accelerators, thiazole-based vulcanization accelerators, sulfenamide-based vulcanization accelerators, thiuram-based vulcanization accelerators, dithiocarbamate-based vulcanization accelerators, and xanthogenate-based vulcanization accelerators. These may be used alone, or two or more may be used in combination.

Examples of the thiuram-based vulcanization accelerator include tetramethylthiuram monosulfide (TS), tetramethylthiuram disulfide (TT), and the like. Examples of the guanidine-based vulcanization accelerator include diphenylguanidine and the like. Examples of the sulfenamide-based vulcanization accelerator include N-t-butylbenzothiazole-2-sulfenamide and the like. Examples of the thiourea-based vulcanization accelerator include ethylene thiourea and the like.

From the perspective of enhancing the adhesion between the rubber layer using the rubber composition and a metal surface by enhancing vulcanization characteristics thereof, the content of the vulcanization accelerator is preferably 0.5 parts by mass or greater, more preferably 0.75 parts by mass or greater, and even more preferably 1.0 part by mass or greater, but preferably 3.5 parts by mass or less, more preferably 3.0 parts by mass or less, and even more preferably 2.5 parts by mass or less, per 100 parts by mass of the diene polymer. Hydroxy group-containing compound

As the hydroxy group-containing compound, various compounds can be used in the range that achieves the effect of the present technology as long as the hydroxy group-containing compound has a hydroxy group. Since the hydroxy group-containing compound has a function to catalyze the bond forming reaction between the sulfur as a vulcanizing agent and the metal atom of the metal surface during the vulcanization of the rubber composition, the adhesion between the rubber layer containing the rubber composition and the metal surface can be enhanced.

In the rubber composition of the present embodiment, the hydroxy group-containing compound is preferably a hydroxy group-containing compound represented by the general formula (1) below.

ROH (1)

In Formula (1), R represents a hydrogen atom, an alkyl group that may have an ether bond and a branch and that has from 1 to 5 carbons, or a hydroxy alkyl group that has from 1 to 10 carbons and 5 or less hydroxy groups.

In the general formula (1) above, examples of the alkyl group of R include a methyl group, an ethyl group, an n-propyl group, an i-propyl group, an n-dibutyl group, an s-butyl group, a t-butyl group, a pentyl group, a hexyl group, a heptyl group, an octyl group, a nonyl group, a decyl group, and the like. Among these, from the perspective of adhesion between the rubber layer using the rubber composition and a metal surface, the alkyl group of R is preferably a methyl group, an ethyl group, an n-propyl group, an i-propyl group, an n-dibutyl group, an s-butyl group, a t-butyl group, and a pentyl group, and more preferably a methyl group, an ethyl group, an n-propyl group, and an i-propyl group.

In the general formula (1) above, examples of the hydroxy alkyl group of R include a hydroxymethyl group, a 1-hydroxyethyl group, a 2-hydroxyethyl group, a dihydroxyethyl group, a 1-hydroxypropyl group, a 2-hydroxypropyl group, a 3-hydroxypropyl group, a dihydroxypropyl group, a trihydroxypropyl group, a 1-hydroxybutyl group, a 2-hydroxybutyl group, a 3-hydroxybutyl group, a 4-hydroxybutyl group, a dihydroxybutyl group, a trihydroxybutyl group, a tetrahydroxybutyl group, a pentahydroxybutyl group, a 1-hydroxypentyl group, a 2-hydroxypentyl group, a 3-hydroxypentyl group, a 4-hydroxypentyl group, a 5-hydroxypentyl group, a dihydroxypentyl group, a trihydroxypentyl group, a tetrahydroxypentyl group, a pentahydroxypentyl group, a methoxymethyl group, a 2-hydroxyethoxyethyl group, a dihydroxypropoxymethyl group, a dihydroxypropoxyethyl group, a trihydroxypropoxymethyl group, a trihydroxypropoxyethyl group, 3-hydroxybis(2-ethoxyethyl)propyl group, and the like. Among these, from the perspective of adhesion between the rubber layer using the rubber composition and a metal surface, a hydroxymethyl group, a 1-hydroxyethyl group, a 2-hydroxyethyl group, a dihydroxyethyl group, a 1-hydroxypropyl group, a 2-hydroxypropyl group, a 3 -hydroxypropyl group, a dihydroxypropyl group, a methoxymethyl group, a 2-hydroxyethoxyethyl group, a dihydroxypropoxymethyl group, and a 3-hydroxybis(2-ethoxyethyl)propyl group are preferable; and a hydroxymethyl group, a 1-hydroxyethyl group, a 2-hydroxyethyl group, a dihydroxyethyl group, a methoxymethyl group, a 2-hydroxyethoxyethyl group, and a 3 -hydroxybis(2-ethoxyethyl)propyl group are more preferable. Taking these into consideration, from the perspective of adhesion between the rubber layer using the rubber composition and the metal surface, R in the general formula (1) above is preferably a hydrogen atom, a methyl group, an ethyl group, an n-propyl group, an i-propyl group, a hydroxymethyl group, a 1-hydroxyethyl group, a 2-hydroxyethyl group, a dihydroxyethyl group, a methoxymethyl group, a 2-hydroxyethoxyethyl group, or a 3-hydroxybis(2-ethoxyethyl)propyl group.

Examples of the hydroxy group-containing compound represented by the general formula (1) above include water, methanol, ethanol, propanol, isopropanol, butanol, ethylene glycol, propylene glycol, butylene glycol, pentylene glycol, diethylene glycol, triethylene glycol, glycerin, 1,2,6-trihydroxyhexane, diglycerin, trimethylolpropane, pentaerythritol, sorbitol, and the like. As the water, the water may be tap water, or may be purified water such as distilled water, ion-exchanged water, and filtered water. Among these, from the perspective of adhesion between the rubber layer using the rubber composition and the reinforcing layer, the hydroxy group-containing compound is preferably at least one type selected from the group consisting of water, methanol, ethanol, propanol, isopropanol, ethylene glycol, propylene glycol, diethylene glycol, triethylene glycol, diglycerin, trimethylolpropane, and pentaerythritol. Water, methanol, ethanol, ethylene glycol, propylene glycol, diethylene glycol, trimethylolpropane, and pentaerythritol are more preferable.

One type of these hydroxy group-containing compounds may be used alone, or two or more types of these hydroxy group-containing compounds may be used in a combination.

The content of the hydroxy group-containing compound is from 0.8 parts by mass to 17 parts by mass per 100 parts by mass of the diene polymer. When the content of the hydroxy group-containing compound is within the range described above, the equivalent weight of hydroxy groups in the rubber composition is set to the appropriate range, thereby exhibiting sufficient catalytic effect of the bonding reaction between the sulfur and the metal surface and thereby obtaining the composition having excellent adhesion between the rubber layer using the rubber composition and the metal surface. The content of the hydroxy group-containing compound is, per 100 parts by mass of the diene polymer, preferably 0.85 parts by mass or greater, more preferably 0.9 parts by mass or greater, even more preferably 0.95 parts by mass or greater, and yet even more preferably 1.0 part by mass or greater, but preferably 16.5 parts by mass or less, more preferably 16 parts by mass or less, even more preferably 15.5 parts by mass or less, and yet even more preferably 15 parts by mass or less. Taking these into consideration, the content of the polyhydric alcohol compound is preferably from 0.85 parts by mass to 16.5 parts by mass, more preferably from 0.9 parts by mass to 16 parts by mass, even more preferably from 0.95 parts by mass to 15.5 parts by mass, and yet even more preferably from 1.0 part by mass to 15 parts by mass, per 100 parts by mass of the diene polymer.

### Other Additives

The rubber composition may contain other additives, if necessary, in a range that the effect of the present technology can be exhibited. Examples of the other additive include fillers, plasticizers, softeners, anti-aging agents, organic activators, antioxidants, antistatic agents, flame retardants, crosslinking-accelerating auxiliaries, vulcanization retarders, antiozonants, process oils (aroma oils), and adhesive auxiliaries.

Examples of the fillers include carbon black, silica (white carbon black), clay, talc, iron oxide, zinc oxide (ZnO), titanium oxide, barium oxide, magnesium oxide, calcium carbonate, magnesium carbonate, zinc carbonate, barium sulfate, mica, diatomaceous earth, and the like. One type of these may be used alone, or two or more types of these may be used in a combination. As the carbon black, any carbon black can be suitably selected and used depending on the purpose. ISAF (Intermediate Super Abrasion Furnace) grade and FEF (Fast Extruding Furnace) grade carbon blacks are preferable. Examples of the silica include crystallized silica, precipitated silica, amorphous silica (e.g. high temperature treated silica), fumed silica, calcined silica, pulverized silica, molten silica, and the like. In particular, silica is known to generate a carbon gel (bound rubber) in the similar manner as in carbon black and can be suitably used if necessary. Examples of the clay include hard clay, pyropyllite clay, kaolin clay, calcined clay, and the like.

Examples of the plasticizer include dioctyl phthalate (DOP), dibutyl phthalate (DBP), dioctyl adipate (DOA), isodecyl succinate, di(ethylene glycol) dibenzoate, pentaerythritol ester, butyl oleate, methyl acetyl ricinoleate, tricresyl phosphate, trioctyl phosphate, trimellitic acid ester, propylene glycol adipate polyester, butylene glycol adipate polyester, naphthenic oil, and the like. One type of these may be used alone, or two or more types of these may be used in a combination.

Specific examples of the softener include aromatic oil, naphthenic oil, paraffinic oil, petroleum resin, vegetable oil, liquid rubber, and the like. One type of these may be used alone, or two or more types of these may be used in a combination.

Examples of the anti-aging agent include N-(1,3-dimethylbutyl)-N′-phenyl-p-phenylenediamine (6PPD), N,N′-dinaphthyl-p-phenylenediamine (DNPD), N-isopropyl-N′-phenyl-p-phenylenediamine (IPPD), styrenated phenol (SP), 2,2,4-trimethyl-1,2-dihydroquinoline polymer (RD), and the like. One type of these may be used alone, or two or more types of these may be used in a combination.

Examples of the organic activator include stearic acid, oleic acid, lauric acid, zinc stearate, and the like. One type of these may be used alone, or two or more types of these may be used in a combination. Examples of the antioxidant include butylhydroxytoluene (BHT) and butylhydroxyanisole (BHA).

Examples of the antistatic agent include quaternary ammonium salts; and hydrophilic compounds such as polyglycols and ethylene oxide derivatives.

Examples of the flame retardant include chloroalkyl phosphates, dimethyl-methyl phosphonates, bromine-phosphorus compounds, ammonium polyphosphates, neopentyl bromide polyethers, brominated polyethers, and the like. Examples of non-halogen-based flame retardant include aluminum hydroxide, magnesium hydroxide, tricresyl phosphate, and diphenyl cresyl phosphate.

A conventional auxiliary for rubber can be used together as a cross-linking promoter. As the auxiliary for rubber, zinc oxide; stearic acid, oleic acid, and Zn salts of these can be used.

Examples of the vulcanization retarder include organic acids such as phthalic anhydride, benzoic acid, salicylic acid, and acetylsalicylic acid; nitroso compounds such as N-nitroso-diphenylamine, N-nitroso-phenyl-β-naphthylamine, and N-nitroso-trimethyl-dihydroquinoline polymer; halides such as trichloromelanine; 2-mercaptobenzimidazole, N-(cyclohexylthio)phthalimide (PVI), and the like. One type of these may be used alone, or two or more types of these may be used in a combination.

Examples of the adhesive auxiliary include triazine thiol compounds (e.g. 2,4,6-trimercapto-1,3,5-triazine and 6-butylamino-2,4-dimercapto-1,3,5-triazine), resorcin, cresol, resorcin-formalin latex, monomethylol melamine, monomethylol urea, ethylene maleimide, cobalt naphthenate, cobalt stearate, cobalt versatate, cobalt dodecanoate, and the like. One type of these adhesive auxiliaries may be used alone, or two or more types of these adhesive auxiliaries may be used in a combination.

### Method of Producing Rubber Composition

The rubber composition according to the present embodiment can be produced by a conventionally known production method. An example of the method of producing the rubber composition according to the present embodiment is a production method including compounding the diene polymer described above, and as necessary, another diene polymer, a polymer other than the diene polymer, and various additives described above; and kneading the mixture using an internal mixer such as a Banbury mixer or a kneader, a roll kneader such as a roll, an extruder, a twin screw extruder, or the like. Rubber composition metal laminate

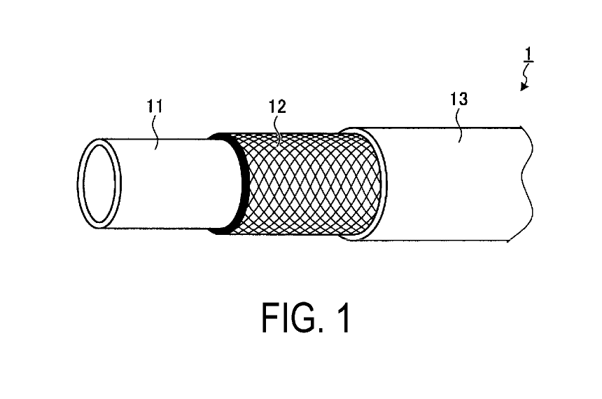

The rubber composition metal laminate according to the present embodiment is a laminate of the rubber composition and a wire reinforcing layer having a metal-plated surface. Examples of the laminate include high pressure hoses, hydraulic hoses, and the like. FIG. 1 is a partial cutaway perspective view of an example of a hydraulic hose according to the present embodiment. As illustrated in FIG. 1, the hydraulic hose 1 is formed cylindrically and includes an inner rubber layer 11 for passing fluid therein, a reinforcing layer 12 provided on the outer side of the inner rubber layer 11, and an outer rubber layer 13 provided on the outer side of the reinforcing layer 12. The reinforcing layer 12 is arranged in the manner that the inner rubber layer 11 and the outer rubber layer 13 sandwich the reinforcing layer 12. The inner rubber layer 11, the reinforcing layer 12, and the outer rubber layer 13 are adhered and fixed due to the vulcanization of the inner rubber layer 11 and the outer rubber layer 13.

### Rubber Layer

As described above, the inner rubber layer 11 and/or the outer rubber layer 13 are rubber layers using the rubber composition according to the present embodiment. From the perspective of weather resistance of the hose, it is preferable to form at least the outer rubber layer 13 using the rubber composition according to the present embodiment. The inner rubber layer 11 is preferably formed by using a rubber composition containing an acrylonitrile butadiene rubber (NBR) having excellent oil resistance as a main component.

The thickness of the inner rubber layer 11 is, for example, preferably from 0.2 mm to 4.0 mm, and more preferably from 0.5 mm to 2.0 mm. Similarly, the thickness of the outer rubber layer 13 is, for example, preferably from 0.2 mm to 4.0 mm, and more preferably from 0.5 mm to 2.0 mm.

### Reinforcing Layer

The reinforcing layer 12 is a wire braid in which steel wires having a surface plated with brass are braided. From the perspective of maintaining the strength of the hydraulic hose 1, the reinforcing layer 12 is a layer provided in between the inner rubber layer 11 and the outer rubber layer 13. Note that, in the example illustrated in FIG. 1, the reinforcing layer 12 is one layer; however, a plurality of the reinforcing layers 12 between which a middle rubber layer is provided may be provided. The reinforcing layer 12 may be, other than a wire braid, spiral wires formed by winding steel wires spirally around the inner rubber layer 11. Materials, and a braiding method, weaving method, or winding method that forms the reinforcing layer 12 can be suitably selected depending on the application, for example depending on pressure resistance. In the hydraulic hose and the like, the reinforcing layer 12 is preferably formed by a wire braid.

Examples of the wire materials include piano wires (carbon steel), hard steel wires, and stainless steel wires. From the perspective of processability and strength, piano wires (carbon-steel) and hard steel wires are particularly preferable as the wire materials.

In order to enhance the adhesion to the rubber layer, the surface of the reinforcing layer 12 is plated with a metal. This metal plating is a brass coating applied on piano wires and hard steel wires. The brass coating is formed by plating a steel wire with copper, plating with zinc over the copper, and then subjecting the wire to thermal diffusion processing.

### Vulcanized Rubber Product

In the rubber composition metal laminate of the rubber composition and the reinforcing layer 12, molecules of the rubber constituting the inner rubber layer 11 and the outer rubber layer 13 are crosslinked by sulfur by being subjected to crosslinking, i.e. vulcanization, in the presence of sulfur. This crosslinking imparts elasticity and tensile strength to the inner rubber layer 11 and the outer rubber layer 13, and adheres the inner rubber layer 11 and the outer rubber layer 13 to the reinforcing layer 12 due to the bond formed between the metal (copper, zinc) constituting the brass coating and the sulfur, at the interface between the rubber layers and the reinforcing layer 12.

Sulfur is preferably blended together with other materials when a compound of the rubber composition is formed. Note that the time at which sulfur is blended is not limited to the time when the compound is prepared as long as molecules forming the diene polymer are crosslinked each other by the sulfur, and as long as the inner rubber layer 11 and the outer rubber layer 13 are adhered to the reinforcing layer 12 due to the bond formed between the metal (copper, zinc) and the sulfur at the interface between the inner rubber layer 11 and the reinforcing layer 12, and the interface between the outer rubber layer 13 and the reinforcing layer 12, and the like.

An example of the method of vulcanization is a method in which the rubber composition is heat treated at a predetermined temperature for a predetermined time period in the presence of sulfur. The vulcanization temperature is preferably from 130° C. to 180° C. The vulcanization time is preferably from 30 minutes to 240 minutes. By a combination of the temperature and the time in these ranges, desired physical properties as a vulcanized rubber product such as elasticity, tensile strength, appearance, adhesion at the interface between the rubber and the metal, and rubber sticking at the interface between the rubber and the metal can be imparted.

The vulcanized rubber product in the present embodiment can be suitably used as hydraulic hose and the like. Examples of the method of producing a hydraulic hose or the like include a steam vulcanization method in which the rubber composition metal laminate is placed in a high pressure container and is crosslinked in a boiler, and an oven vulcanization method in which the rubber composition metal laminate is covered by nylon cloth or the like and vulcanized in a hot-air drying furnace. In general, the steam vulcanization method is a batch type treatment, and the oven vulcanization method is a continuous type treatment. The method of producing a hydraulic hose is preferably an oven vulcanization method which is a continuous type treatment.

### Method of Producing Vulcanized Rubber Product

A method of producing a vulcanized rubber product according to the present embodiment will be described below. Here, an example of the case where a hydraulic hose is produced as the vulcanized rubber product will be described.

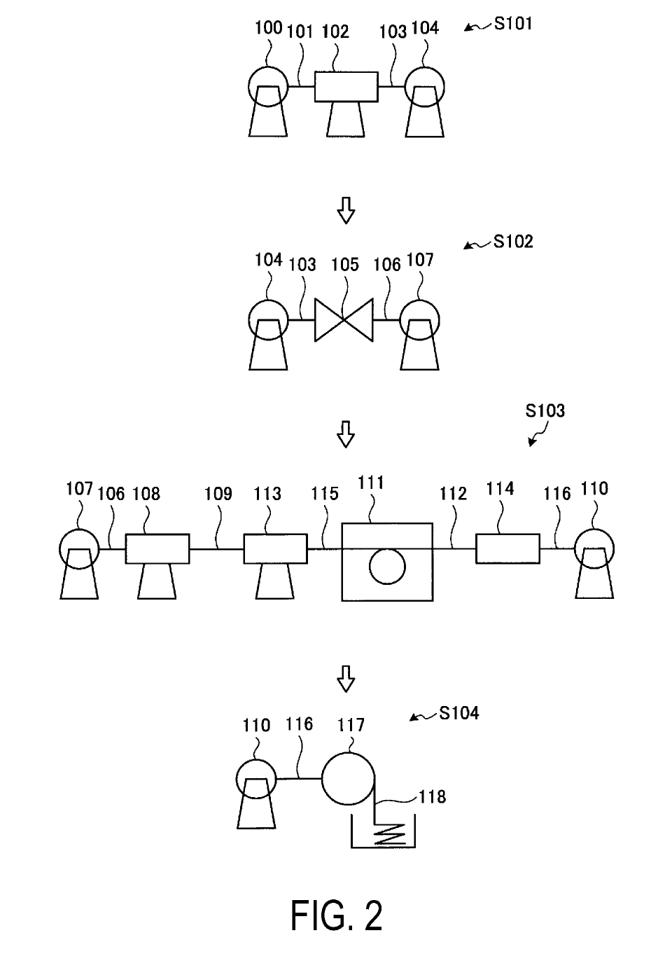

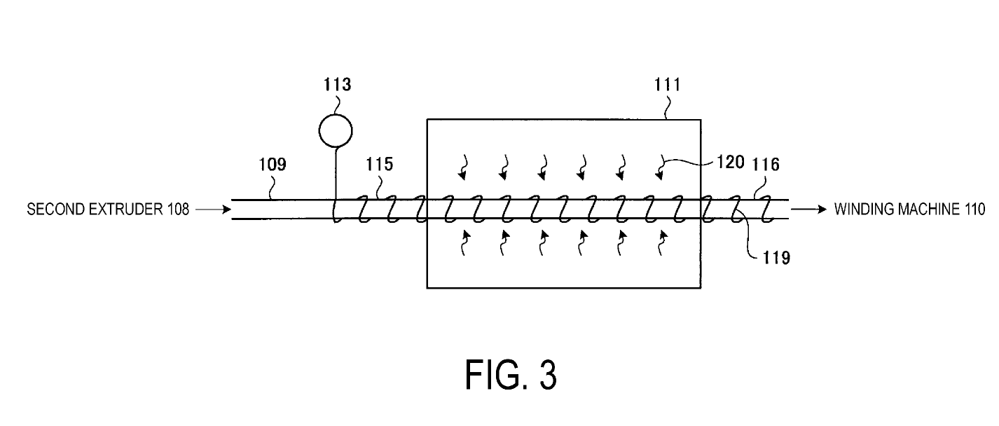

The method of producing a hydraulic hose according to the present embodiment will be described with reference to FIGS. 2 and 3. FIG. 2 is an explanatory diagram of production steps of a hydraulic hose using a rubber composition according to an embodiment of the present technology. FIG. 3 is an explanatory diagram of vulcanization steps of the hydraulic hose using the rubber composition according to the embodiment of the present technology. Production steps of hose

As illustrated in FIG. 2, the rubber hose is obtained by an extrusion step of a rubber material that forms the inner rubber layer 11 (step S101), a braiding step of the reinforcing layer 12 (step S102), an extrusion-vulcanization step of the outer rubber layer 13 (step S103), and a removing step of mandrel 101 (step S104). The produced rubber hose is subjected to a water pressure test and a winding test step, and then packaged and shipped.

In the step S101, the outer circumferential surface of a mandrel 101 that is sent out from an unwinding machine 100 is covered by an unvulcanized inner rubber layer 11 via a first extruder 102. A hose 103 which is covered by the inner rubber layer 11 is wound by a winding-unwinding machine 104.

Next, in the step S102, a reinforcing layer 12 is braided by a braiding machine 105 in a manner that the inner rubber layer 11 constituting the hose 103 sent out from the winding-unwinding machine 104 is covered, to form a hose 106, and then the hose 106 is wound by the winding-unwinding machine 107. A metal wire is used as the code of this reinforcing layer 12. As the metal wire, a steel wire plated with brass is used in order to impart excellent adhesion to rubber. Note that the reinforcing layer 12 may be formed by spirally winding the metal wire around the inner rubber layer 11 formed around the mandrel 101.

Next, in the step S103, a hose body 109 is formed by covering the reinforcing layer 12 of the hose 106 sent out from the winding-unwinding machine 107 with an unvulcanized outer rubber layer 13 using a second extruder 108, and the formed hose body 109 is wound by a winding machine 110. In the present embodiment, a vulcanized hose 112 obtained by a vulcanization step performed by a vulcanization device 111 is wound by the winding machine 110 after the hose body 109 is sent out from the second extruder 108 but before wound by the winding machine 110; however, the vulcanization step can be performed after the hose body 109 is wound by the winding machine 110. Furthermore, before and after the vulcanization device 111, a wrapping device 113 and an unwrapping device 114 are provided in order to wrap or unwrap a protective cloth such as a nylon cloth around the hose body 109. Note that, in FIG. 2, after the vulcanization, the unvulcanized hose 115 on which a nylon cloth is wrapped by the wrapping device 13 becomes a hose 116 that is in a state before unwrapping the nylon cloth. The vulcanization step will be described below.

Next, in the step S104, a hydraulic hose 118 is completed by removing the mandrel 101, using a mandrel removing device 117, from the hose 116 that is sent out from the winding machine 110 and unwrapped after the vulcanization.

### Vulcanization Step

As illustrated in FIG. 3, by the wrapping device 113, a nylon cloth 119 is wrapped around the hose body 109 sent out from the second extruder 108. The hose body 109 covered with the nylon cloth 119 is then transferred into the vulcanization device 111. The vulcanization device 111 is a continuous vulcanization device with hot-air circulation that allows the vulcanization to proceed by hot wind 120. The vulcanization method is an oven vulcanization method.

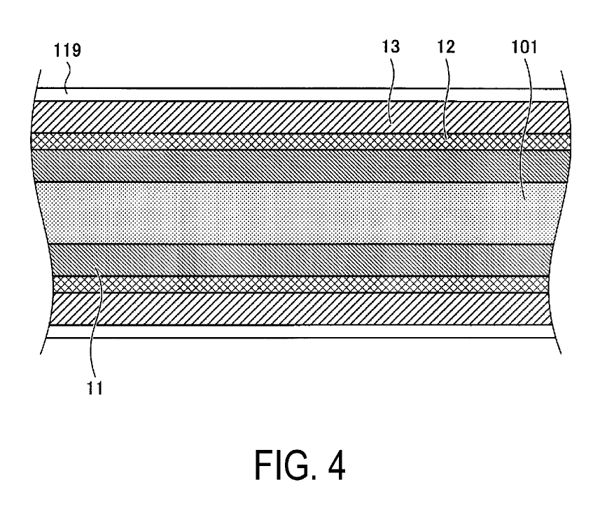

FIG. 4 is a partially cross-sectional view explaining an example of a layer structure around a mandrel 101 inserted into a vulcanization device. As illustrated in FIG. 4, the inner rubber layer 11 is formed around the mandrel 101, the reinforcing layer 12 is further formed therearound, and the outer rubber layer 13 is further formed therearound. The nylon cloth 119 is wrapped around the outer rubber layer 13, and the outer rubber layer 13 is heated in this condition to proceed the vulcanization step.

As described above, the vulcanization temperature is preferably from 130° C. to 180° C., and the vulcanization time (that is, the vulcanization time in the vulcanization device 111) is preferably from 30 minutes to 240 minutes. Using this temperature range and the vulcanization time, a hydraulic hose having excellent adhesion between the inner rubber layer 11 and the reinforcing layer 12 and between the outer rubber layer 13 and the reinforcing layer 12 is obtained. Here, a hydraulic hose having excellent adhesion between an inner rubber layer 11 and/or an outer rubber layer 13 and a metal reinforcing layer 12 can be produced by forming the inner rubber layer 11 and/or the outer rubber layer 13 using the rubber composition according to the embodiment described above.

Note that, according to the rubber composition, since a suitable water content can be stably maintained in the composition until immediately before the vulcanization, adhesion failure and decrease in adhesion due to insufficient water content can be suppressed in an oven vulcanization method that causes great amount of water evaporation. The rubber composition according to the embodiment can be, needless to say, suitably used in a production of rubber products using conventionally known another vulcanization method. Examples of another vulcanization method include press vulcanization, steam vulcanization, hot water vulcanization, and the like.

Furthermore, in the embodiment described above, the production steps of continuous treatment are exemplified; however, the vulcanized rubber products can be also produced by a method in which the rubber layer and the reinforcing layer are produced in separate steps and then adhered.

The hydraulic hose produced by the production method according to the present embodiment can be used for various applications. The hydraulic hose can be suitably used as, for example, air conditioner hose for vehicles, power steering hose, hydraulic hose for hydraulic systems of construction vehicles, and the like.

Furthermore, the present embodiment was described using a hydraulic hose as the rubber composition metal laminate and the vulcanized rubber product; however, the present technology is not limited to this. For example, the present embodiment can be similarly employed in other rubber laminates such as conveyor belts.

As described above, according to the rubber composition metal laminate, the vulcanized rubber product, and the method of producing the vulcanized rubber product, a vulcanized rubber product having excellent adhesion between a rubber layer and a reinforcing layer can be provided even by a continuous production method using an oven vulcanization method. In particular, a composition that can form a rubber product having excellent adhesion toward a reinforcing layer can be provided even in the case where the composition is stored in a dried state for a long period of time. This vulcanized rubber product can be suitably used for hydraulic hose, high pressure hose, and the like.

### EXAMPLES

Embodiments of the present technology are described in further detail with reference to the examples performed in order to clearly show the effect of the present technology. Note that the present technology is not limited by the examples and comparative examples described below.

### 1. Preparation of Rubber Composition

### Example 1

To 100 parts by mass of a diene polymer containing 40 mass % of acrylonitrile-butadiene rubber (trade name: Nancar 3345, manufactured by Nantex Industry Co., Ltd.; acrylonitrile content: 34mass %; Mooney viscosity (ML1+4, 100° C.): 45), 30 mass % of ethylene-propylene-diene rubber (trade name: EPT 4070, manufactured by Mitsui Chemicals, Inc.; ethylene content: 56mass %; ethylidene norbornene content: 8mass %; Mooney viscosity (ML1+4, 125° C.): 47), and 30 mass % of styrene butadiene rubber (trade name: Nipol 1502, manufactured by Zeon Corporation; emulsion polymerization SBR; bonded styrene content: 23.5 mass %; Mooney viscosity (ML1 +4, 100° C.): 52), 2 parts by mass of sulfur (manufactured by Hosoi Chemical Industry Co., Ltd.), 1 part by mass of water, 1.7 parts by mass of sulfenamide-based vulcanization accelerator (N-t-butylbenzothiazole-2-sulfenamide; trade name: NOCCELER NS-P, manufactured by Ouchi Shinko Chemical Industrial Co., Ltd.), 0.3 parts by mass of antiscorching agent (N-cyclohexylthiophthalimide, manufactured by

Flexsys), 62 parts by mass of ISAF grade carbon black (trade name: Sho Black N220, manufactured by Showa Cabot K.K.), 15 parts by mass of hard clay (trade name: Suprex Clay, manufactured by Kentucky-Tennessee Clay Company), 5 parts by mass of Zinc Oxide III (manufactured by Seido Chemical Industry Co., Ltd.), 1 part by mass of stearic acid (manufactured by Nippon Oil & Fats Co., Ltd.), 2.4 parts by mass of antiozonant (trade name: Ozonone 6C, manufactured by Seiko Chemical Co., Ltd.), 10 parts by mass of plasticizer (dioctyl adipate; trade name: DIACIZER DOA, manufactured by Mitsubishi Kasei Vinyl Company), and 12 parts by mass of process oil (aroma oil; trade name: A-OMIX, manufactured by Sankyo Yuka Kogyo K.K.) were blended and kneaded by a Banbury mixer to produce a rubber composition. The adhesion of the produced rubber composition was evaluated. The compounded amount of each of the components are shown in Table 1 below and evaluation results are shown in Table 3 below.

### Example 2

A rubber composition was produced in the same manner as in Example 1 except for changing the compounded amount of the water to 3 parts by mass, and the rubber composition was evaluated. The compounded amount of each of the components are shown in Table 1 below and evaluation results are shown in Table 3 below.

### Example 3

A rubber composition was produced in the same manner as in Example 1 except for changing the compounded amount of the water to 6 parts by mass, and the rubber composition was evaluated. The compounded amount of each of the components are shown in Table 1 below and evaluation results are shown in Table 3 below.

### Example 4

A rubber composition was produced in the same manner as in Example 1 except for changing the compounded amount of the water to 15 parts by mass, and the rubber composition was evaluated. The compounded amount of each of the components are shown in Table 1 below and evaluation results are shown in Table 3 below.

### Example 5

A rubber composition was produced in the same manner as in Example 1 except for compounding 1 part by mass of ethanol in place of the water, and the rubber composition was evaluated. The compounded amount of each of the components are shown in Table 1 below and evaluation results are shown in Table 3 below.

### Example 6

A rubber composition was produced in the same manner as in Example 5 except for changing the compounded amount of the ethanol to 6 parts by mass, and the rubber composition was evaluated. The compounded amount of each of the components are shown in Table 1 below and evaluation results are shown in Table 3 below.

### Example 7

A rubber composition was produced in the same manner as in Example 1 except for compounding 2 parts by mass of diethylene glycol in place of the water, and the rubber composition was evaluated. The compounded amount of each of the components are shown in Table 1 below and evaluation results are shown in Table 3 below.

### Example 8

A rubber composition was produced in the same manner as in Example 7 except for changing the compounded amount of the diethylene glycol to 3 parts by mass, and the rubber composition was evaluated. The compounded amount of each of the components are shown in Table 1 below and evaluation results are shown in Table 3 below.

### Example 9

A rubber composition was produced in the same manner as in Example 7 except for changing the compounded amount of the diethylene glycol to 6 parts by mass, and the rubber composition was evaluated. The compounded amount of each of the components are shown in Table 1 below and evaluation results are shown in Table 3 below.

### Example 10

A rubber composition was produced in the same manner as in Example 1 except for compounding 3 parts by mass of pentaerythritol in place of the water, and the rubber composition was evaluated. The compounded amount of each of the components are shown in Table 1 below and evaluation results are shown in Table 3 below.

### Example 11

A rubber composition was produced in the same manner as in Example 10 except for changing the compounded amount of the pentaerythritol to 15 parts by mass, and the rubber composition was evaluated. The compounded amount of each of the components are shown in Table 1 below and evaluation results are shown in Table 3 below.

### Comparative Example 1

A rubber composition was produced in the same manner as in Example 1 except for blending no water, and the rubber composition was evaluated. The compounded amount of each of the components is shown in Table 2 below and evaluation results are shown in Table 4 below.

### Comparative Example 2

A rubber composition was produced in the same manner as in Example 1 except for changing the compounded amount of the water to 0.5 parts by mass, and the rubber composition was evaluated. The compounded amount of each of the components is shown in Table 2 below and evaluation results are shown in Table 4 below.

### Comparative Example 3

A rubber composition was produced in the same manner as in Example 1 except for changing the compounded amount of the water to 0.75 parts by mass, and the rubber composition was evaluated. The compounded amount of each of the components is shown in Table 2 below and evaluation results are shown in Table 4 below.

### Comparative Example 4

A rubber composition was produced in the same manner as in Example 1 except for changing the compounded amount of the water to 18 parts by mass, and the rubber composition was evaluated. The compounded amount of each of the components is shown in Table 2 below and evaluation results are shown in Table 4 below.

### Comparative Example 5

A rubber composition was produced in the same manner as in Example 5 except for changing the compounded amount of the ethanol to 0.75 parts by mass, and the rubber composition was evaluated. The compounded amount of each of the components is shown in Table 2 below and evaluation results are shown in Table 4 below.

### Comparative Example 6

A rubber composition was produced in the same manner as in Example 7 except for changing the compounded amount of the diethylene glycol to 0.75 parts by mass, and the rubber composition was evaluated. The compounded amount of each of the components is shown in Table 2 below and evaluation results are shown in Table 4 below.

### Comparative Example 7

A rubber composition was produced in the same manner as in Example 10 except for changing the compounded amount of the pentaerythritol to 0.75 parts by mass, and the rubber composition was evaluated. The compounded amount of each of the components is shown in Table 2 below and evaluation results are shown in Table 4 below.

### Comparative Example 8

A rubber composition was produced in the same manner as in Example 2 except for changing the compounded amount of the sulfur to 0.4 parts by mass, and the rubber composition was evaluated. The compounded amount of each of the components is shown in Table 2 below and evaluation results are shown in Table 4 below.

### Comparative Example 9

A rubber composition was produced in the same manner as in Example 8 except for changing the compounded amount of the sulfur to 5.5 parts by mass, and the rubber composition was evaluated. The compounded amount of each of the components is shown in Table 2 below and evaluation results are shown in Table 4 below.

### Comparative Example 10

A rubber composition was produced in the same manner as in Example 7 except for changing the compounded amount of the diethylene glycol to 18 parts by mass, and the rubber composition was evaluated. The compounded amount of each of the components is shown in Table 2 below and evaluation results are shown in Table 4 below.

### Comparative Example 11

A rubber composition was produced in the same manner as in Example 10 except for changing the compounded amount of the pentaerythritol to 18 parts by mass, and the rubber composition was evaluated. The compounded amount of each of the components is shown in Table 2 below and evaluation results are shown in Table 4 below.

TABLE 1

| | Examples | | | | | | | | | | |
|---|---|---|---|---|---|---|---|---|---|---|---|
| | 1 | 2 | 3 | 4 | 5 | 6 | 7 | 8 | 9 | 10 | 11 |
| NBR | 40 | 40 | 40 | 40 | 40 | 40 | 40 | 40 | 40 | 40 | 40 |
| EPDM | 30 | 30 | 30 | 30 | 30 | 30 | 30 | 30 | 30 | 30 | 30 |
| SBR | 30 | 30 | 30 | 30 | 30 | 30 | 30 | 30 | 30 | 30 | 30 |
| Sulfur | 2 | 2 | 2 | 2 | 2 | 2 | 2 | 2 | 2 | 2 | 2 |
| Water | 1 | 3 | 6 | 15 | | | | | | | |
| Ethanol | | | | | 1 | 6 | | | | | |
| Diethylene | | | | | | | 2 | 3 | 6 | | |
| glycol | | | | | | | | | | | |
| Pentaerythritol | | | | | | | | | | 3 | 15 |
| Vulcanization | 1.7 | 1.7 | 1.7 | 1.7 | 1.7 | 1.7 | 1.7 | 1.7 | 1.7 | 1.7 | 1.7 |
| accelerator | | | | | | | | | | | |
| Antiscorching | 0.3 | 0.3 | 0.3 | 0.3 | 0.3 | 0.3 | 0.3 | 0.3 | 0.3 | 0.3 | 0.3 |
| agent | | | | | | | | | | | |
| Carbon black | 62 | 62 | 62 | 62 | 62 | 62 | 62 | 62 | 62 | 62 | 62 |
| Hard clay | 15 | 15 | 15 | 15 | 15 | 15 | 15 | 15 | 15 | 15 | 15 |
| Zinc oxide | 5 | 5 | 5 | 5 | 5 | 5 | 5 | 5 | 5 | 5 | 5 |
| Stearic acid | 1 | 1 | 1 | 1 | 1 | 1 | 1 | 1 | 1 | 1 | 1 |
| Antiozonant | 2.4 | 2.4 | 2.4 | 2.4 | 2.4 | 2.4 | 2.4 | 2.4 | 2.4 | 2.4 | 2.4 |
| Plasticizer | 10 | 10 | 10 | 10 | 10 | 10 | 10 | 10 | 10 | 10 | 10 |
| Process oil | 12 | 12 | 12 | 12 | 12 | 12 | 12 | 12 | 12 | 12 | 12 |

TABLE 2

| | Comparative Examples | | | | | | | | | | |
|---|---|---|---|---|---|---|---|---|---|---|---|
| | 1 | 2 | 3 | 4 | 5 | 6 | 7 | 8 | 9 | 10 | 11 |
| NBR | 40 | 40 | 40 | 40 | 40 | 40 | 40 | 40 | 40 | 40 | 40 |
| EPDM | 30 | 30 | 30 | 30 | 30 | 30 | 30 | 30 | 30 | 30 | 30 |
| SBR | 30 | 30 | 30 | 30 | 30 | 30 | 30 | 30 | 30 | 30 | 30 |
| Sulfur | 2 | 2 | 2 | 2 | 2 | 2 | 2 | 0.4 | 5.5 | 2 | 2 |
| Water | | 0.5 | 0.75 | 18 | | | | 3 | | | |
| Ethanol | | | | | 0.75 | | | | | | |
| Diethylene | | | | | | 0.75 | | | 3 | 18 | |
| glycol | | | | | | | | | | | |
| Pentaerythritol | | | | | | | 0.75 | | | | 18 |
| Vulcanization | 1.7 | 1.7 | 1.7 | 1.7 | 1.7 | 1.7 | 1.7 | 1.7 | 1.7 | 1.7 | 1.7 |
| accelerator | | | | | | | | | | | |
| Antiscorching | 0.3 | 0.3 | 0.3 | 0.3 | 0.3 | 0.3 | 0.3 | 0.3 | 0.3 | 0.3 | 0.3 |
| agent | | | | | | | | | | | |
| Carbon black | 62 | 62 | 62 | 62 | 62 | 62 | 62 | 62 | 62 | 62 | 62 |
| Hard clay | 15 | 15 | 15 | 15 | 15 | 15 | 15 | 15 | 15 | 15 | 15 |
| Zinc oxide | 5 | 5 | 5 | 5 | 5 | 5 | 5 | 5 | 5 | 5 | 5 |
| Stearic acid | 1 | 1 | 1 | 1 | 1 | 1 | 1 | 1 | 1 | 1 | 1 |
| Antiozonant | 2.4 | 2.4 | 2.4 | 2.4 | 2.4 | 2.4 | 2.4 | 2.4 | 2.4 | 2.4 | 2.4 |
| Plasticizer | 10 | 10 | 10 | 10 | 10 | 10 | 10 | 10 | 10 | 10 | 10 |
| Process oil | 12 | 12 | 12 | 12 | 12 | 12 | 12 | 12 | 12 | 12 | 12 |

Details of each of the components listed in Tables 1 and 2 are as described below.

NBR: trade name: Nancar 3345, manufactured by Nantex Industry Co., Ltd; acrylonitrile content: 34 mass %; Mooney viscosity (ML1+4, 100° C.): 45

EPDM: trade name: EPT 4070, manufactured by Mitsui Chemicals, Inc.; ethylene content: 56 mass %; ethylene norbornene content: 8 mass %; Mooney viscosity (ML1+4, 125° C.): 47

SBR: trade name: Nipol 1502, manufactured by Zeon Corporation; emulsion polymerization SBR; bonding styrene content: 23.5 mass %; Mooney viscosity (ML1+4, 100° C.): 52

Water: tap water

Ethanol: manufactured by Kanto Chemical Co., Ltd.

Diethylene glycol: manufactured by Nippon Shokubai Co., Ltd.

Pentaerythritol: manufactured by The Nippon Synthetic Chemical Industry Co., Ltd.

Sulfur: manufactured by Hosoi Chemical Industry Co., Ltd.

Vulcanization accelerator: N-t-butylbenzothiazole-2-sulfenamide; trade name: NOCCELER NS-P, manufactured by Ouchi Shinko Chemical Industrial Co., Ltd.

Antiscorching agent: N-cyclohexylthiophthalimide, manufactured by Flexsys

Carbon black: ISAF grade carbon black; trade name: Sho Black N220, manufactured by Showa Cabot K.K.

Hard clay: trade name: Suprex Clay, manufactured by Kentucky-Tennessee Clay Company

Zinc oxide: Zinc Oxide III, manufactured by Seido Chemical Industry Co., Ltd.

Stearic acid: manufactured by NOF Corporation

Antiozonant: trade name: Ozonone 6C, manufactured by Seiko Chemical Co., Ltd.

Plasticizer: dioctyl adipate; trade name: DIACIZER DOA, manufactured by Mitsubishi Kasei Vinyl Company

Process oil: aroma oil; trade name: A-OMIX, manufactured by Sankyo Yuka Kogyo K.K.

### 2. Evaluation of Rubber Composition

Using each of the rubber compositions obtained in Examples 1 to 11 and Comparative Examples 1 to 11, a hose-shaped test piece having a rubber outer layer formed from each of the rubber compositions and a reinforcing layer formed from brass-plated wires was produced in the manner described below. Brass-plated wires were first wounded in a braided manner around a mandrel having an outer diameter of 34 mm to form a reinforcing layer. An unvulcanized sheet having a thickness of 2.5 mm prepared by using each of the obtained rubber compositions was then adhered on the reinforcing layer to obtain an unvulcanized hose-shaped test piece. Thereafter, curing tape (protective cloth) formed from nylon 66 was wound around to cover the outer side of the unvulcanized hose-shaped test piece, and then vulcanization was performed.

The vulcanization was performed under the two types of conditions described below, and adhesive strength and rubber sticking of the obtained vulcanized hose-shaped test piece were evaluated. Note that each of the adhesive strength and the rubber sticking was shown as an average value obtained from 10 measured values.

Vulcanization conditions 1: The unvulcanized hose-shaped test piece produced by using the rubber composition immediately after the kneading was subjected to vulcanization in a steam can at 142° C. for 90 minutes (steam vulcanization).

Vulcanization conditions 2: The unvulcanized hose-shaped test piece produced by using the rubber composition immediately after the kneading was subjected to vulcanization in an oven under normal pressure at 142° C. for 135 minutes (oven vulcanization).

Each of the vulcanized hose-shaped test pieces obtained by the vulcanization conditions 1 and the vulcanization conditions 2 described above was evaluated for the adhesive strength (kN/m) and the rubber sticking (%). Note that the adhesive strength (kN/m) is a degree of force (kN) per unit width (m) that is required when an outer side rubber layer is peeled off from the interface between the outer side rubber layer and a reinforcing layer at the peeling rate of 50 mm/min. Note that the rubber sticking is a proportion of residues of the outer side rubber layer of the vulcanized hose-shaped test piece remaining on the surface of the reinforcing layer, and is a percentage showing the proportion of the area of the residual rubber layer relative to the total surface area of the reinforcing layer. Each of values of the adhesive strength (kN/m) and the rubber sticking (%) is an average value obtained from 10 measurements. The evaluation results are shown in Tables 3 and 4. Note that, in

Tables 3 and 4, the evaluation result of adhesion 1 is an evaluation result of the vulcanized hose-shaped test piece vulcanized by the vulcanization conditions 1, and the evaluation result of adhesion 2 is an evaluation result of the vulcanized hose-shaped test piece vulcanized by the vulcanization conditions 2. When the value of the adhesive strength is 2.5 kN/m or greater and the rubber sticking is 60% or greater, the adhesion is excellent.

Furthermore, appearance of the outer side rubber layer was evaluated visually for each of the vulcanized hose-shaped test pieces, and evaluated based on the following criteria.

Excellent: No concave failure (pores) was observed.

Poor: Concave failure (pores) was observed.
Measurement was not performed.

TABLE 3

| | | Examples | | | | | |
|---|---|---|---|---|---|---|---|
| | | 1 | 2 | 3 | 4 | 5 | 6 |
| Evaluation | Adhesive | 4.4 | 4.3 | 4.2 | 4.1 | 4.2 | 4.3 |
| result of | strength | | | | | | |
| adhesion 1 | (kN/m) | | | | | | |
| | Rubber | 100 | 100 | 100 | 95 | 95 | 100 |
| | sticking (%) | | | | | | |
| Evaluation | Adhesive | 2.7 | 3.6 | 3.9 | 3.9 | 4.0 | 4.2 |
| result of | strength | | | | | | |
| adhesion 2 | (kN/m) | | | | | | |
| | Rubber | 55 | 75 | 85 | 85 | 60 | 95 |
| | sticking (%) | | | | | | |

| | | | | | | |
|---|---|---|---|---|---|---|
| Rubber appearance | — | — | Excellent | Excellent | Excellent | Excellent |

| | | Examples | | | | |
|---|---|---|---|---|---|---|
| | | 7 | 8 | 9 | 10 | 11 |
| Evaluation | Adhesive | 4.6 | 4.6 | 4.6 | 4.5 | 4.0 |
| result of | strength | | | | | |
| adhesion 1 | (kN/m) | | | | | |
| | Rubber | 100 | 100 | 100 | 100 | 90 |
| | sticking (%) | | | | | |
| Evaluation | Adhesive | 4.1 | 4.2 | 4.2 | 4.0 | 3.2 |
| result of | strength | | | | | |
| adhesion 2 | (kN/m) | | | | | |
| | Rubber | 75 | 90 | 90 | 60 | 75 |
| | sticking (%) | | | | | |

| | | | | | |
|---|---|---|---|---|---|
| Rubber appearance | Excellent | Excellent | Excellent | Excellent | Excellent |

TABLE 4

| | | Comparative Examples | | | | | |
|---|---|---|---|---|---|---|---|
| | | 1 | 2 | 3 | 4 | 5 | 6 |
| Evaluation | Adhesive strength | 4.4 | 4.4 | 4.4 | 4.2 | 4.4 | 4.4 |
| result of | (kN/m) | | | | | | |
| adhesion 1 | Rubber sticking (%) | 100 | 100 | 100 | 95 | 100 | 100 |
| Evaluation | Adhesive strength | 1.6 | 2.0 | 2.7 | 3.6 | 2.6 | 2.6 |
| result of | (kN/m) | | | | | | |
| adhesion 2 | Rubber sticking (%) | 0 | 5 | 35 | 85 | 35 | 30 |

| | | | | | | |
|---|---|---|---|---|---|---|
| Rubber appearance | Excellent | — | — | Poor | Excellent | Excellent |

| | | Comparative Examples | | | | |
|---|---|---|---|---|---|---|
| | | 7 | 8 | 9 | 10 | 11 |
| Evaluation | Adhesive strength | 4.4 | 0.5 | 1.5 | 3.2 | 4.3 |
| result of | (kN/m) | | | | | |
| adhesion 1 | Rubber sticking (%) | 100 | 0 | 20 | 85 | 75 |
| Evaluation | Adhesive strength | 2.5 | 0.5 | 2.9 | 2.7 | 2.8 |
| result of | (kN/m) | | | | | |
| adhesion 2 | Rubber sticking (%) | 25 | 0 | 60 | 50 | 50 |

| | | | | | |
|---|---|---|---|---|---|
| Rubber appearance | Excellent | Excellent | Excellent | Poor | Poor |

As is clear from Tables 3 and 4, excellent adhesion was achieved in both the cases of the steam vulcanization method and the oven vulcanization method for Examples 1 to 11, in which the hydroxy group-containing compound was blended in a manner that the equivalent weight of hydroxy groups became a predetermined amount in the diene polymer. On the other hand, in the cases where no hydroxy group-containing compounds were blended or the equivalent weight of hydroxy groups of the hydroxy group-containing compound was less than the predetermined range, it was found that the evaluation result of the adhesion as a result of using the oven vulcanization conditions was significantly deteriorated (Comparative Examples 1 to 3 and 5 to 7). Furthermore, when the equivalent weight of hydroxy groups of the polyhydric alcohol compound was greater than the predetermined range, the rubber appearance was significantly deteriorated while sufficient evaluation result of the adhesion was achieved even in the case of the oven vulcanization method (Comparative Examples 4, 10, and 11). It is conceived that these results were due to deterioration in balance of the catalytic function of the bonding reaction of the metal surface and the sulfur by the hydroxy group-containing compound. Furthermore, when the content of sulfur was greater than the predetermined range, it was found that the evaluation result of the adhesion tended to be inferior in both the vulcanization methods (Comparative Example 9), and when the content of sulfur was less than the predetermined range, it was found that the adhesive strength was significantly deteriorated (Comparative Example 8). It is conceived that these results were due to deterioration in balance of the catalytic function of the bonding reaction of the metal surface and the sulfur by the hydroxy group-containing compound.

1. A rubber composition comprising:
100 parts by mass of a diene polymer that can be vulcanized by sulfur,
from 0.5 parts by mass to 5 parts by mass of sulfur, and
from 0.8 parts by mass to 17 parts by mass of a hydroxy group-containing compound having a molecular weight of 200 or less.

2. The rubber composition according to claim 1, wherein the hydroxy group-containing compound is represented by the general formula (1):
ROH (1)
where, R represents a hydrogen atom, an alkyl group that may have an ether bond and a branch and that has from 1 to 5 carbons, or a hydroxy alkyl group that may have an ether bond and a branch and that has from 1 to 10 carbons and 5 or less hydroxy groups.

3. A rubber composition metal laminate comprising: a reinforcing layer having a metal surface, and a rubber layer containing the rubber composition described in claim 1 provided on the metal surface.

4. The rubber composition metal laminate according to claim 3, wherein the metal surface is brass-plated.

5. The rubber composition metal laminate according to claim 3, wherein the reinforcing layer has a braided structure in which wires are braided or a spiral structure.

6. A vulcanized rubber product obtained by using the rubber composition described in claim 1.

7. A vulcanized rubber product, wherein the rubber layer of the rubber composition metal laminate described in claim 3 is adhered to the reinforcing layer by vulcanization in the presence of sulfur.

8. The vulcanized rubber product according to claim 7, wherein the vulcanized rubber product is a hose.

9. A rubber composition metal laminate comprising: a reinforcing layer having a metal surface, and a rubber layer containing the rubber composition described in claim 2 provided on the metal surface.

10. The rubber composition metal laminate according to claim 9, wherein the metal surface is brass-plated.

11. The rubber composition metal laminate according to claim 10, wherein the reinforcing layer has a braided structure in which wires are braided or a spiral structure.

12. A vulcanized rubber product obtained by using the rubber composition described in claim 2.

13. A vulcanized rubber product, wherein the rubber layer of the rubber composition metal laminate described in claim 4 is adhered to the reinforcing layer by vulcanization in the presence of sulfur.

14. The vulcanized rubber product according to claim 13, wherein the vulcanized rubber product is a hose.

15. A vulcanized rubber product, wherein the rubber layer of the rubber composition metal laminate described in claim 5 is adhered to the reinforcing layer by vulcanization in the presence of sulfur.

16. The vulcanized rubber product according to claim 15, wherein the vulcanized rubber product is a hose.
